(19) United States
(12) Patent Application Publication
(10) Pub. No.: US 2026/0043657 A1
(43) Pub. Date: Feb. 12, 2026

(54) IN-STORE CUSTOMER GUIDANCE SYSTEM AND STORE SERVER FOR IN-STORE CUSTOMER GUIDANCE SYSTEM

(71) Applicant: Toshiba Tec Kabushiki Kaisha, Tokyo (JP)

(72) Inventor: Tomoharu NAGAI, Ota Tokyo (JP)

(21) Appl. No.: 19/240,744

(22) Filed: Jun. 17, 2025

(30) Foreign Application Priority Data
Aug. 6, 2024 (JP) 2024-129723

(51) Int. Cl. G01C 21/20; G06Q 30/0251; G06V 20/52; G06V 40/10

(52) U.S. Cl. CPC G01C 21/206; G06Q 30/0261; G06Q 30/0268; G06Q 30/0271; G06V 20/53; G06V 40/10

(57) ABSTRACT

According to one embodiment, a customer guidance system includes a camera, a checkout apparatus, and a store server. The store server has a storage unit, a communication unit, and a control unit configured to identify and store a degree of congestion for different regions of the store, determine a current status of a customer in the store, select a region of the store as a suggested destination for the customer based on congestion degrees and the customer's current status. The control unit generates a prompt including the suggested destination and inputs the prompt to a generative AI trained to generate a customer guidance response for guiding the customer to the suggested destination. The customer guidance response is then supplied to the customer.

### CROSS-REFERENCE TO RELATED APPLICATION

This application is based upon and claims the benefit of priority from Japanese Patent Application No. 2024-129723, filed Aug. 6, 2024, the entire contents of which are incorporated herein by reference.

### FIELD

Embodiments described herein relate generally to a customer guidance system and an information processing apparatus associated with such a system.

### BACKGROUND

In a retail store, such as a supermarket, congestion may occur due to concentration of customers in areas where popular items are displayed and/or in the checkout area. In such cases, in the store, a method for limiting the occurrence of congestion by notifying the customers of information about an area where congestion occurs may be adopted.

In the related art, a system for guiding a user to an area having low congestion in a facility such as a theme park has been proposed. However, since the system is applied to a facility such as the theme park, the scenario of a customer shopping in a retail store is not considered, and it is difficult to directly apply the related art system to a retail store situation.

### BRIEF DESCRIPTION OF THE DRAWINGS

FIG. 1 is a schematic diagram of a guidance promotion system according to an embodiment.

FIG. 2 is a block diagram of a mobile terminal according to an embodiment.

FIG. 3 is a block diagram of a store server according to an embodiment.

FIG. 4 shows an example of a data configuration of a merchandise master according to an embodiment.

FIG. 5 shows an example of a data configuration of a customer master according to an embodiment.

FIG. 6 shows an example of a data configuration of a congestion degree table according to an embodiment.

FIG. 7 shows an example of a data configuration of a promotion database according to the embodiment.

FIG. 8 shows an example of a data configuration of a customer record database according to the embodiment.

FIG. 9 is a block diagram depicting aspects of a functional configuration of a mobile terminal and a store server according to an embodiment.

FIG. 10 is a flowchart of congestion degree calculation processing performed by a store server according to an embodiment.

FIG. 11 is a sequence diagram showing an example of control processing performed by a mobile terminal and a store server according to an embodiment.

FIG. 12 shows an example of a data configuration of a merchandise registration file according to a modification.

FIG. 13 is a block diagram depicting aspects of a functional configuration of a mobile terminal and a store server according to a modification.

### DETAILED DESCRIPTION

A problem to be solved by the disclosure is to provide an information processing system, apparatus, and method that can more efficiently guide a customer to regions of a store while taking into account at least the current congestion situation in the store.

In general, according to one embodiment, an in-store customer guidance system includes a camera, a checkout apparatus in a first region of a store, and a store server. The store server includes: a storage unit, a communication unit, and a control unit. The control unit is configured to identify a degree of congestion for each of a plurality regions of the store including the first region; store the identified degree of congestion for each of the plurality of regions in the storage unit; determine a current status of a customer in the store; select a region of the store in the plurality of regions as a suggested destination based on the stored degree of congestion for each of the plurality of regions and the determined current status of the customer; generate a prompt including the suggested destination; input the prompt to a generative AI trained to generate a customer guidance response for guiding the customer to the suggested destination; and output the customer guidance response to the customer.

Hereinafter, certain example embodiments related to an information processing apparatus and an information processing method will be described with reference to the drawings. In the following, an example will be described in which an embodiment of the present disclosure is applied to a retail store such as a supermarket or a department store (hereinafter, also simply referred to as a store), but the disclosure is not limited to the example embodiment.

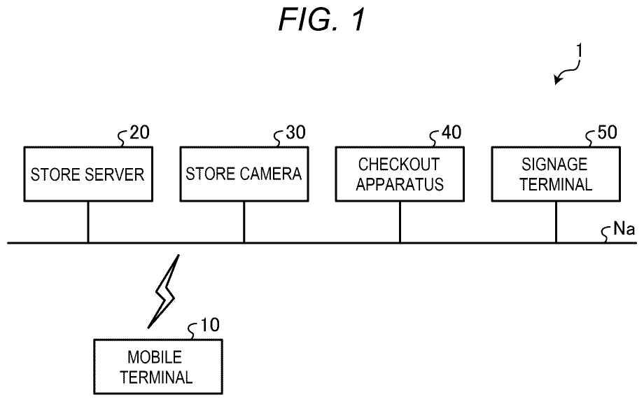

FIG. 1 is a diagram showing an example of a schematic configuration of a guidance promotion system 1 according to an embodiment. As shown in FIG. 1, the guidance promotion system 1 includes a mobile terminal 10, a store server 20, a store camera 30, a checkout apparatus 40, and a signage terminal 50. In some embodiments, the signage terminal 50 is not required in the guidance promotion system 1.

The guidance promotion system 1 is provided in a store and performs action support such as guiding a customer in the store to a destination. In the guidance promotion system 1, the store server 20, the store camera 30, the checkout apparatus 40, and the signage terminal 50 are communicably connected to one another via a network Na such as a local area network (LAN). The mobile terminal 10 is communicably connected to the store server 20 by wireless communication via a wireless access point or the like connected to the network Na. That is, the mobile terminal 10 can move in the store while maintaining communication with the store server 20.

The mobile terminal 10 is, for example, a terminal apparatus such as a smartphone or a tablet terminal prepared by the store. For example, the mobile terminal 10 may be attached to a shopping cart used by the customer within the store. Alternatively, the mobile terminal 10 may be a user terminal such as a smartphone owned by the customer.

The mobile terminal 10 transmits and receives various types of information to and from the store server 20. For example, the mobile terminal 10 transmits a check-in notification to the store server 20 when the customer enters the store or begins using the mobile terminal 10 in the store.

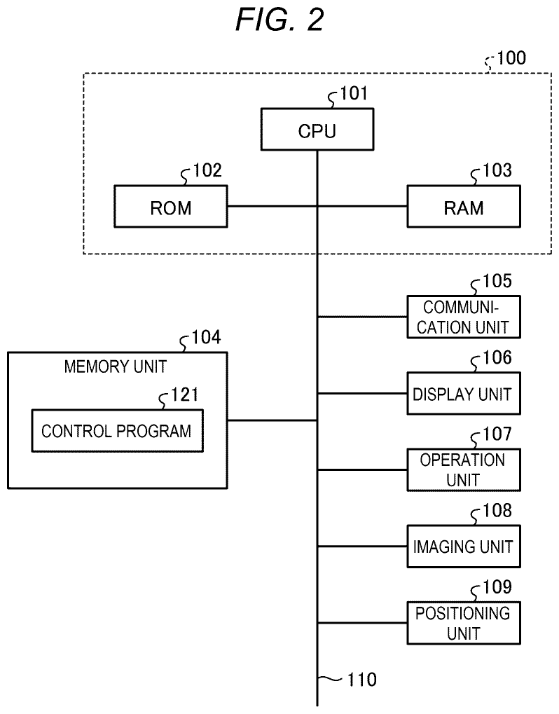

The mobile terminal 10 receives, from the store server 20, guidance information indicating an area in the store that is the movement destination (also referred to as a guided destination or suggested destination), and displays the received guidance information or a portion thereof on a display unit 106 (see FIG. 2). The mobile terminal 10 may also notify the user of the received guided destination in some other manner.

The store server 20 is, for example, a server apparatus provided in the store. The store server 20 cooperates with various other apparatuses connected via the network Na to manage operations of the store. For example, the store server 20 generates the guidance information for guiding the customer to the movement destination area according to a congestion situation in the store and a status (situation) of the customer. The store server 20 transmits the guidance information to the mobile terminal 10 and the signage terminal 50.

The store camera 30 is, for example, an imaging apparatus that captures an image of each area in the store. Here, the area means a plurality of areas obtained by partitioning an entire area in the store where the customer can move according to predetermined division. The division for partitioning the area is not particularly limited, and for example, the area in the store may be partitioned into a grid pattern, or may be divided according to categories of merchandise to be sold or a position of a display shelf where the merchandise is displayed. It is assumed that a checkout area where the checkout apparatus 40 is placed is partitioned off as a separate or distinct area. In an embodiment, the checkout area may be divided for each checkout apparatus 40 type such that the checkout apparatuses 40 operated by a store clerk is in an area distinct from the checkout apparatuses 40 operated by the customer.

The store camera 30 captures an image of each area in the store and transmits the captured image (hereinafter, also referred to as an area image) to the store server 20. A plurality of store cameras 30 may be provided such that images of the entire area in the store can be captured.

The checkout apparatus 40 is a merchandise sales data processing apparatus that executes registration of merchandise being purchased by the customer and checkout (settlement) processing on the registered merchandise. A plurality of checkout apparatuses 40 are provided in the checkout area in the store. The plurality of checkout apparatuses 40 includes different types such as a checkout apparatus 40 where the store clerk performs the registration operation and the checkout operation (a staffed register), a checkout apparatus 40 where the store clerk performs the registration operation but the customer performs the checkout operation (a semi-self-service register), and a checkout apparatus 40 where the customer performs both the registration and checkout operations (a self-service register).

The signage terminal 50 is provided in an area such as an entrance of the store or an entrance to the checkout area. The signage terminal 50 is an apparatus or a system for performing digital signage display. For example, the signage terminal 50 incorporates a computer configuration such as a control device, a communication device, a storage device, and a display device, stores information received via the communication device in the storage device, and then displays the stored information on the display device. The signage terminal 50 cooperates with the store server 20 to display various types of information on the display device. The signage terminal 50 may include an imaging device (e.g., a store camera 30) that captures an image of the vicinity of the signage terminal 50.

Next, a hardware configuration of the mobile terminal 10 will be described. FIG. 2 is a block diagram showing an example of the hardware configuration of the mobile terminal 10 according to the embodiment.

As shown in FIG. 2, the mobile terminal 10 includes a central processing unit (CPU) 101, which is an example of a processor, a read only memory (ROM) 102, a random access memory (RAM) 103, a memory unit 104, a communication unit 105, the display unit 106, an operation unit 107, an imaging unit 108, and a positioning unit 109.

The CPU 101 is an example of a processor and performs overall control of each unit in the mobile terminal 10. The ROM 102 stores various programs. The RAM 103 is a workspace for loading programs and various types of data.

The memory unit 104 is a non-volatile memory such as a hard disc drive (HDD) or a flash memory in which stored information is retained even when a power supply is turned off. The memory unit 104 includes a control program 121.

The control program 121 provides a control program for controlling the mobile terminal 10. The CPU 101, the ROM 102, the RAM 103, and the memory unit 104 are connected to one another via a bus 110 or the like. The CPU 101, the ROM 102, and the RAM 103 constitute a control unit 100. That is, the control unit 100 executes control processing for the mobile terminal 10 by the CPU 101 operating according to the control program 121 stored in the ROM 102 or the memory unit 104 and then loaded into the RAM 103.

The control unit 100 is connected to the communication unit 105, the display unit 106, the operation unit 107, the imaging unit 108, and the positioning unit 109 via the bus 110.

The communication unit 105 is a communication interface that can be connected to the network Na by wireless communication such as a wireless local area network (LAN). The communication unit 105 transmits and receives various types of information to and from the store server 20 and the like.

The display unit 106 is a display device such as a liquid crystal display (LCD). The display unit 106 displays various types of information under control of the CPU 101.

The operation unit 107 is a touch panel provided at the display unit 106. The operation unit 107 outputs, to the CPU 101, operation content received via an input device. The operation unit 107 can be an input device such as a keyboard and a pointing device.

The imaging unit 108 is an imaging device including an image sensor such as a charge coupled device (CCD) or a complementary metal oxide semiconductor (CMOS). For example, the imaging unit 108 captures an image of the customer's face or the like corresponding to a characteristic feature of the customer (hereinafter, also referred to as a customer image).

The positioning unit 109 measures or otherwise identifies a position of the mobile terminal 10 in the store. In other words, the positioning unit 109 acquires position information corresponding the current location of the customer in the store. A method for acquiring the customer position information is not particularly limited, and any known method can be adopted. The positioning unit 109 may be, for example, a position measurement device using a beacon positioning technique. In this case, by providing a terminal corresponding to the positioning technique such as beacon positioning at various positions in the store, the position of the mobile terminal 10 can be measured by the positioning system formed by the terminal and the positioning unit 109.

The positioning unit 109 may acquire the position information of the mobile terminal 10 by performing indoor positioning using Wi-Fi, for example.

When the above-described indoor positioning method is adopted, the positioning unit 109 first measures a radio strength at a plurality of access points (APs) provided in the aisles in the store, on merchandise shelves, or the like from the mobile terminal 10. Then, a relative position of the mobile terminal 10 with respect to each AP can be specified based on each measured radio strength. The positioning unit 109 then identifies the position of the mobile terminal 10 based on the relative positions of the mobile terminal 10 from each installation position of the APs.

As another method, the positioning unit 109 may specify the position of the mobile terminal 10 by a global positioning system (GPS) function of the mobile terminal 10 and acquire the customer's position information. For locations such as a below ground floor where GPS positioning is difficult due to weak radio waves, positioning may be performed by providing a base station that transmits a signal including position information. Such an indoor positioning technique may be called an indoor messaging system (IMES), and the position of the mobile terminal 10 can be specified by receiving a signal transmitted from the base station by the mobile terminal 10.

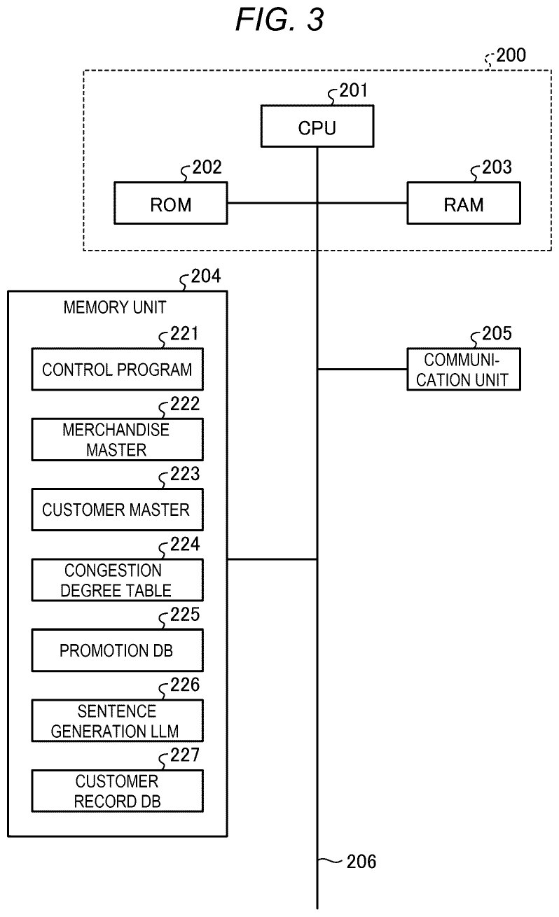

Next, a hardware configuration of the store server 20 will be described. FIG. 3 is a block diagram showing an example of the hardware configuration of the store server 20 according to the embodiment.

As shown in FIG. 3, the store server 20 includes a CPU 201, which is an example of a processor, a ROM 202, a RAM 203, a memory unit 204, a communication unit 205, and the like.

The CPU 201 is an example of a processor and performs overall control of each unit in the store server 20. The ROM 202 stores various programs. The RAM 203 is a workspace for loading programs and various types of data.

The memory unit 204 is a non-volatile memory such as an HDD or a flash memory in which stored information is retained even when the power supply is turned off. The memory unit 204 includes a control program 221, a merchandise master 222, a customer master 223, a congestion degree table 224, a promotion database (DB) 225, a sentence generation LLM 226, and a customer record database (DB) 227.

The control program unit 221 stores a control program for controlling the store server 20. The CPU 201, the ROM 202, the RAM 203 and the memory unit 204 are connected to one another via a bus 206. The CPU 201, the ROM 202, and the RAM 203 constitute a control unit 200. That is, the control unit 200 executes control processing of the store server 20 by the CPU 201 operating according to the control program 221 stored in the ROM 202 or the memory unit 204 and then loaded into the RAM 203.

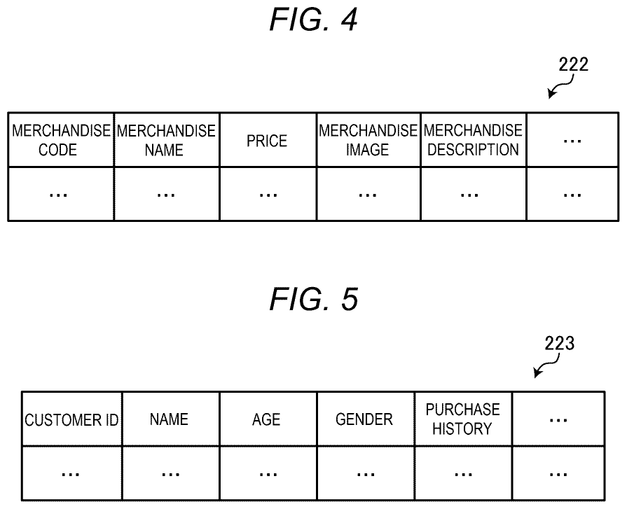

The merchandise master 222 is a data table or a database for managing merchandise information about merchandise handled at the store. FIG. 4 shows an example of a data configuration of the merchandise master 222. As shown in FIG. 4, the merchandise master 222 stores, in association with a merchandise code, merchandise information such as a merchandise name, a price, a merchandise image, and a merchandise description.

The merchandise image is, for example, an image depicting the merchandise. The merchandise description includes information such as a location where the merchandise is in the store (for example, a store area where the merchandise is displayed for sale), a merchandise category, and a keyword. The merchandise category represents a category of the merchandise corresponding to the merchandise code. A plurality of merchandise categories may be stored for each item of merchandise. For example, “fruit”, “orange”, “food”, and “beverage” are stored as the merchandise categories for a merchandise name “orange juice”.

The keyword is text (e.g., a word or phrase) evocative of a feature or aspect of the merchandise, such as descriptive information regarding the specific merchandise type, an aspect related to the manner of production for the merchandise, a country of origin, or a manufacturer or brand of the merchandise. A plurality of keywords may be stored for each item of merchandise. For example, “fruit juice 100%” and “produced in America” are stored as keywords for the merchandise name “orange juice”.

Here, the merchandise category and the keyword are not limited to a natural language, and such entries or the like may be stored in a semantic vector format as calculated using a known natural language processing technique. Alternatively, the merchandise category and the keyword entries may be in both a natural language format and a semantic vector format.

The information stored in the merchandise master 222 is not limited to the example in FIG. 4. For example, the merchandise master 222 may store, in association with the merchandise code, information indicating the area where the merchandise corresponding to the merchandise code is sold (or displayed) within the store.

Referring back to FIG. 3, the customer master 223 is a data table or a database permitting the store to manage customer information. FIG. 5 shows an example of a data configuration of the customer master 223. As shown in FIG. 5, the customer master 223 stores, in association with a customer ID uniquely identifying the customer, customer information such as a name, age, gender, and a purchase history of the customer. Such customer information is an example of feature information related to the customer or customer feature information.

The purchase history stores a category, a merchandise name (or merchandise code), and the like of each item merchandise either previously registered or purchased by the customer. The purchase history is an example of preference information indicating preference of the customer. The customer feature information may include preference information derived from the purchase history. For example, in the purchase history, information about the merchandise subjected to a checkout processing at the checkout apparatus 40 is registered. Specifically, in the checkout processing at the checkout apparatus 40, the customer ID of the customer is received by the checkout apparatus 40, and the information about the merchandise subjected to the checkout processing is included in the purchase history associated with the customer ID.

Contents of the customer information are not limited to the above example. For example, when customers are identified using biometric information, information indicating a face feature of the customer or the like may be in the customer information.

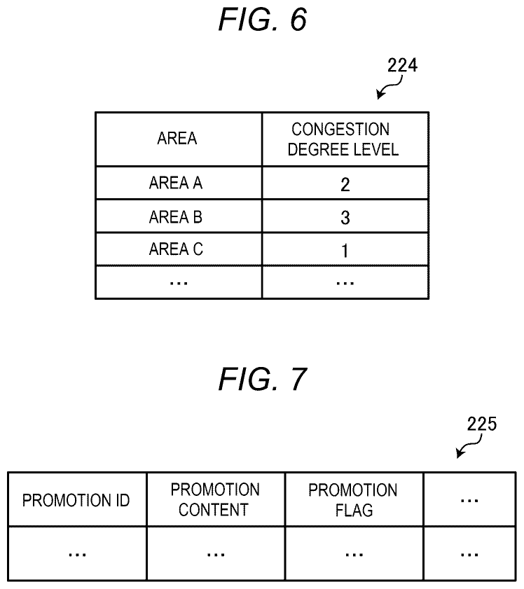

Referring back to FIG. 3, the congestion degree table 224 is a data table or a database for managing a congestion degree in each area in the store. FIG. 6 shows an example of a data configuration of the congestion degree table 224. As shown in FIG. 6, the congestion degree table 224 stores, in association with each area in the store, a congestion degree level.

The area entry is, for example, identification information that allows specifying of each store area. For example, an area may be a sales floor area (e.g., produce department), a store aisle number, or the like where the merchandise in the store is displayed. An identified area may also be a store area (checkout area) where a checkout apparatus 40 is provided. Such checkout areas may be set according to the type(s) of checkout apparatus 40 provided therein.

The congestion degree level is an example of an indicator of the congestion degree. In the embodiment, the congestion degree is, for example, the number of people (customers) identified or estimated as being in the area. Here, any known method can be adopted for calculating the congestion degree. For example, the number of people captured in the area image from an imaging unit 108 can be detected using a known image recognition technique, and the number of detected people can be used as the congestion degree.

When the above-described method is adopted, for example, by defining a case where the number of people detected in the area image is “less than 10” as a congestion degree level “1”, the number of detected people is “10 or more but less than 20” as a congestion degree level “2”, and the number of detected people is “20 or more but less than 30” as a congestion degree level “3”, a congestion degree level can be calculated based on the number of detected people.

A method for representing the congestion degree level is not limited to the above-described method. For example, the congestion degree level may be represented by “high”, “medium”, and “low”. The number of increments in the congestion degree level is not limited to three, and may be any number.

Referring back to FIG. 3, the promotion DB 225 is a data table or a database for managing a promotion related to the merchandise or a service handled by the store. FIG. 7 shows an example of a data configuration of the promotion DB 225. As shown in FIG. 7, the promotion DB 225 stores, in association with a promotion ID, promotion information such as a promotion content and a promotion flag corresponding to the promotion ID.

The promotion ID is identification information that allows uniquely identifying the promotion. The promotion content is, for example, coupon issuance such as “issuance of free coupon for one can of preferred beer”, a discount service such as “10% off total purchase when using self-service register”, “10% off specific merchandise”, or “10 yen discount on specific merchandise”. The promotion content may include a merchandise code of merchandise that is a promotion target and identification information that allows identifying an area related to the promotion target.

The promotion flag is flag information defining whether the promotion of the promotion ID corresponding to the promotion flag is in an applicable state. The promotion flag is binary flag information where, in this example, the flag is “1” when valid (hereinafter, also referred to as an ON state) and the flag is “0” when invalid (hereinafter, also referred to as an OFF state). Specifically, when a promotion flag is in the ON state, the corresponding promotion is an applicable promotion, and when the promotion flag is in the OFF state, the corresponding promotion is a non-applicable promotion. The promotion flag may be manually set to ON or OFF by an employee such as the store clerk, or may be automatically set to ON or OFF. In the latter case, the store server 20 (for example, the control unit 200) may switch a promotion flag of a predetermined promotion ID to ON or OFF depending on such variables as a day of a week, a time of a day, or the like. Alternatively, the store server 20 (for example, the control unit 200) may switch the promotion flag of certain promotion IDs to ON or OFF according to the congestion situation in the store.

Referring back to FIG. 3, the sentence generation LLM 226 is a generative AI for generating text, and is, for example, a large language model (LLM). The sentence generation LLM 226 receives input of text (a prompt) including a query text, and generates a response text for the query text. The response text provides a response or answer to the content and/or query in the prompt. In an embodiment, a LLM is used as the generative AI, but the generative AI is not limited to LLMs and other types of generative AI may be adopted as long as response text or the like can be generated therefrom.

The sentence generation LLM 226 can be trained using a known deep learning technique and outputs response text based on various conditions such as the query content in the prompt. For example, a condition in the prompt can be an area to which the customer is to be guided or a condition associated with the querying for recommended merchandise.

The sentence generation LLM 226 in the embodiment generates second guidance information (response text) according to the input of a prompt generated based on first guidance information including a guided area and customer-specific promotion content. Details of the first guidance information, the second guidance information, the guided area, and the customer-specific promotion content will be described below.

The sentence generation LLM 226 may be subjected to fine-tuning to be specialized for use in the store adopting the guidance promotion system 1. The fine-tuning may change the content of a response to a received prompt or may change the phrasing of a response sentence to be output. For example, the sentence generation LLM 226 used in the embodiment may have been trained on or for specific phrasing examples to be more characteristic of the store adopting the guidance promotion system 1 in such aspects such as response tone or word choices.

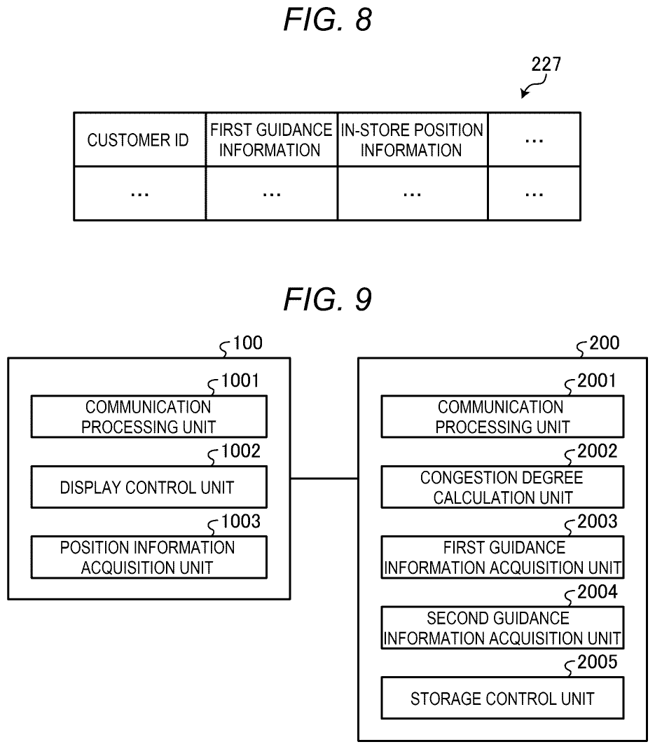

Referring back to FIG. 3, the customer record DB 227 is a data table or a database for managing the guidance information provided to the customer and an action record of the customer in the store in association with each other. FIG. 8 shows an example of a data configuration of the customer record DB 227. As shown in FIG. 8, the customer record DB 227 stores, in association with the customer ID that allows uniquely identifying the customer, customer record information such as the first guidance information and in-store position information corresponding to the customer ID. When a customer whose customer ID is not stored in the customer master 223 uses the guidance promotion system 1, information related to an attribute of the customer (hereinafter, also referred to as attribute information) extracted from a face image or the like of the customer may be stored in a customer ID field.

The first guidance information is an example of guidance information for guiding a customer to a destination. The first guidance information includes the guided area output by a guidance action calculation AI and the customer-specific promotion content. Here, the guided area is an area corresponding to the guided destination (a destination) that is presented to the customer after being selected by the guidance action calculation AI from among areas stored in the congestion degree table 224. The customer-specific promotion content is a promotional content to be presented to the customer as selected by the guidance action calculation AI from among promotion content whose promotion flags stored in the promotion DB 225 are valid.

The in-store position information is position information on the customer acquired by the positioning unit 109 of the mobile terminal 10.

The customer record information may include the time at which the customer record information was stored in the customer record DB 227 by the control unit 200 of the store server 20. The customer record information may include the second guidance information previously supplied to the customer.

Referring back to FIG. 3, the control unit 200 is connected to the communication unit 205 via the bus 206. The communication unit 205 is a communication interface such as an LAN I/F (Interface), and is connected to the network Na. The communication unit 205 transmits and receives various types of information to and from, for example, the mobile terminal 10, the store camera 30, the checkout apparatus 40, and the signage terminal 50 via the network Na. The communication unit 205 can also be connected to a network such as the Internet or another information processing apparatus under control of the control unit 200.

Next, a functional configuration of the mobile terminal 10 and the store server 20 will be described. FIG. 9 is a block diagram showing an example of the functional configuration of the mobile terminal 10 and the store server 20 according to the embodiment.

As shown in FIG. 9, the control unit 100 in the mobile terminal 10 includes a communication processing unit 1001, a display control unit 1002, and a position information acquisition unit 1003 as functional configurations.

Specifically, the control unit 100 (CPU 101) of the mobile terminal 10 executes the control program 121 stored in the memory unit 104 to implement the above-described functional configurations. In this embodiment, each functional configuration is a software configuration implemented by cooperation between the processor and the program in the mobile terminal 10, but is not limited thereto, and may be a hardware configuration in which a part or all of the functional configuration is implemented by a dedicated circuit or the like. The functional configuration of the mobile terminal 10 is not limited thereto.

The communication processing unit 1001 transmits various types of information to the store server 20. For example, upon receiving a check-in confirmation instruction via the operation unit 107 or the like, the communication processing unit 1001 transmits, to the store server 20, a check-in notification including the customer ID of the customer who is an operator and the position information acquired by the positioning unit 109. Here, the check-in notification is notification information for notifying that the customer has arrived at the store or that the customer has started shopping in the store.

The check-in confirmation instruction is not limited to an operation via the operation unit 107, and the check-in confirmation instruction may be, for example, reading a check-in code symbol provided at the entrance of the store. In this case, the code symbol may include an address of the store server 20 that is an access destination, in addition to a command instructing the start of check-in processing.

The customer ID may be received via the operation unit 107. Alternatively, the customer ID may be received by reading the customer ID displayed in the form of a barcode or the like on a membership card or the like by the imaging unit 108 or the like. When the mobile terminal 10 is the user terminal carried by the customer, the customer ID stored in advance in the mobile terminal 10 may be transmitted to the store server 20. When each customer is identified using the biometric information, the customer image captured by the imaging unit 108 may be transmitted to the store server 20 instead of the customer ID. In this case, the mobile terminal 10 may display, on the display unit 106, a message for guiding the customer to face the imaging unit 108.

When the mobile terminal 10 does not acquire the customer ID, the communication processing unit 1001 controls the imaging unit 108 to capture the customer image upon receiving the check-in confirmation instruction. In this case, the mobile terminal 10 may display, on the display unit 106, the message for guiding the customer to face the imaging unit 108. Then, the communication processing unit 1001 may transmit, to the store server 20, the check-in notification including the customer image and the position information instead of the customer ID.

After the check-in is completed, the communication processing unit 1001 transmits and receives various types of information to and from the store server 20 in cooperation with other functional configurations.

The display control unit 1002 displays various types of information on the display unit 106. For example, the display control unit 1002 displays, on the display unit 106, various screens for supporting an action of the customer in the store. For example, the display control unit 1002 displays, on the display unit 106, a guidance sentence and a promotion sentence contained in the second guidance information based on the second guidance information provided from the store server 20. Details of the second guidance information, the guidance sentence, and the promotion sentence will be described below.

The position information acquisition unit 1003 acquires position information on a terminal thereof in the store. Specifically, the position information acquisition unit 1003 cooperates with the positioning unit 109 to acquire the position information on the terminal thereof as the position information on the customer who operates the terminal. The position information acquisition unit 1003 cooperates with the communication processing unit 1001 to transmit the acquired position information on the customer to the store server 20 together with the customer ID. Timing for acquiring the position information or timing for transmitting the position information to the store server 20 is not particularly limited, and for example, information may be transmitted every 10 seconds. The position information acquisition unit 1003 may transmit the position information to the store server 20 at timing when the check-in notification or the like is transmitted, that is, at timing when the customer performs a predetermined action.

The control unit 200 of the store server 20 includes a communication processing unit 2001, a congestion degree calculation unit 2002, a first guidance information acquisition unit 2003, a second guidance information acquisition unit 2004, and a storage control unit 2005 as functional configurations.

Specifically, the control unit 200 (CPU 201) of the store server 20 executes the control program 221 stored in the memory unit 204 to implement the above-described functional units. In this embodiment, each functional unit is a software configuration implemented by cooperation between the processor and the program in the store server 20, but is not limited thereto, and such functions or functional units may be provided in whole or in part by a hardware configuration such as a dedicated circuit or the like. The functional configuration of the store server 20 is not limited thereto.

The communication processing unit 2001 is an example of a provision unit. The communication processing unit 2001 transmits and receives various types of information. For example, the communication processing unit 2001 receives the area image of each area from the store camera 30 provided in each area in the store. The communication processing unit 2001 also cooperates with other functional configurations to transmit information acquired by other functional configurations, processing results of other functional configurations, and the like to an external apparatus.

The congestion degree calculation unit 2002 calculates the congestion degree for each area in the store based on the area image captured by the store camera 30. Specifically, the congestion degree calculation unit 2002 calculates, using a known image recognition technique or the like, the congestion degree level of each area from the area image of each area received by the communication processing unit 2001. The congestion degree calculation unit 2002 updates the congestion degree table 224 based on the calculated congestion degree level. Although timing (frequency) when the congestion degree calculation unit 2002 calculates the congestion degree is not particularly limited, for example, it is preferable that the congestion degree is calculated at frequency in consideration of real-time performance such as an interval of one minute.

The first guidance information acquisition unit 2003 is an example of a first acquisition unit, a second acquisition unit, a guided destination determination unit, and a fourth acquisition unit. The first guidance information acquisition unit 2003 determines the guided area that is a guided destination of the customer and the promotion content to be provided to the customer in relation to the guidance according to a status of each area in the store and a status of the customer. Then, the first guidance information acquisition unit 2003 acquires (generates) the first guidance information including the guided area and the promotion content.

Specifically, the first guidance information acquisition unit 2003 determines the status of the customer according to various types of information (notifications) transmitted from the mobile terminal 10. For example, when the check-in notification is received from the mobile terminal 10, the first guidance information acquisition unit 2003 identifies that the customer has arrived at the store.

The first guidance information acquisition unit 2003 identifies the status of the customer according to a position of the customer in the store. For example, when position information indicating the vicinity of the checkout area is transmitted, the first guidance information acquisition unit 2003 determines that the customer is performing checkout. When a position other than near the entrance of the store or the checkout area is transmitted, the first guidance information acquisition unit 2003 determines that the customer is presently shopping or moving around in the store. When position information near the entrance of the store is transmitted, the first guidance information acquisition unit 2003 may determine that the customer has just arrived at the store.

When the check-in notification is received from the mobile terminal 10, the first guidance information acquisition unit 2003 refers to the customer master 223 and determines whether there is a corresponding customer ID. When there is a corresponding customer ID in the customer master 223, the first guidance information acquisition unit 2003 acquires customer information corresponding to the customer ID. On the other hand, when there is no corresponding customer ID in the customer master 223, the first guidance information acquisition unit 2003 acquires attribute information of the customer from the customer image in the check-in notification. The methods for acquiring such attribute information from the customer image is not particularly limited, and any known image recognition technique or the like can be used.

The first guidance information acquisition unit 2003 acquires the congestion degree of each of a plurality of areas set in the store. Specifically, the first guidance information acquisition unit 2003 refers to the congestion degree table 224 and acquires the congestion degree level of each area. Here, the first guidance information acquisition unit 2003 selects an area whose congestion degree level is to be acquired according to the status of the customer determined above.

For example, when it is determined that the customer has arrived at the store, the first guidance information acquisition unit 2003 acquires the congestion degree level of an area other than the checkout area. For example, when it is determined that the customer is shopping, the first guidance information acquisition unit 2003 acquires the congestion degree level of an area other than the checkout area. For example, when it is determined that the customer is performing checkout, the first guidance information acquisition unit 2003 acquires the congestion degree level of the checkout area. More specifically, the congestion degree level of the different areas by checkout apparatus 3 in each area is acquired. Even in a case where it is determined that the customer is performing (or about to perform) checkout, when the congestion level in the checkout area exceeds a threshold, the first guidance information acquisition unit 2003 may guide the customer away from the checkout area(s) by acquiring the congestion degree level of an area other than the checkout area.

The first guidance information acquisition unit 2003 also refers to the promotion DB 225 and acquires, as the customer-specific promotion content, promotion content corresponding to a promotion ID whose promotion flag is ON. Here, the first guidance information acquisition unit 2003 may select the promotion content to be acquired according to the status of the customer as determined above. For example, the first guidance information acquisition unit 2003 may acquire the promotion content associated with the area whose congestion degree level is extracted.

The first guidance information acquisition unit 2003 also generates the first guidance information including the guided destination and the promotion content based on the customer information acquired from the customer master 223 or the attribute information acquired from the customer image, the congestion degree levels acquired from the congestion degree table 224, and the promotion content acquired from the promotion DB 225.

Specifically, the first guidance information acquisition unit 2003 may preferentially identify an area whose congestion degree level is less than the threshold in acquired congestion degree levels for the respective areas. Next, the first guidance information acquisition unit 2003 selects the guided destination (the suggested area) based on characteristics of the identified area and characteristics of the customer.

For example, the first guidance information acquisition unit 2003 selects, as the guided destination, an area where merchandise matching the preferences of the customer is sold. The preferred merchandise may be derived from the purchase history in the customer information. For example, the first guidance information acquisition unit 2003 selects, as the guided destination, an area where merchandise considered likely to be suitable for the customer (based on customer attributes) is sold. For example, customer attributes such as age and gender of the customer may be derived from the customer information or other attribute information.

For example, when it is determined that the customer is performing checkout, the first guidance information acquisition unit 2003 sets, as the guided destination, an area where a checkout apparatus 40 of a type considered most suitable for the age of the customer is provided, based on the type of the checkout apparatus 40 provided in the extracted area and the attribute such as the age of the customer derived from the customer information or the attribute information. As an example, when a customer is an elderly person, such customers tend to prefer a checkout apparatus 40 of the type where the store clerk is involved (staffed register), so an area where a staffed register is provided is set as the guided destination for the customer of elderly age. The area that is the guided destination is not limited to a single area, and a plurality of areas may be selected when appropriate.

The first guidance information acquisition unit 2003 also selects the promotion content related to the guided destination area as customer-specific promotion content. Then, the first guidance information acquisition unit 2003 generates the first guidance information including the guided (suggested) destination area and the customer-specific promotion content.

Accordingly, the area that is the guided destination as determined/set by the first guidance information acquisition unit 2003 is an area where the congestion degree level is low and the characteristics of the customer, as derived from the customer information or the attribute information, are reflected. Since the first guidance information acquisition unit 2003 generates first guidance information including the promotion content related to the guided destination area, it is possible to attract the customer to the guided destination area.

When a current position (position information) of the customer is already inside or within the area set as the guided destination, the first guidance information acquisition unit 2003 may prevent generation of additional first guidance information by setting the guided destination value to “no”. When congestion degree levels of all areas are less than a threshold, the first guidance information acquisition unit 2003 may prevent the generation of the first guidance information by setting the guided destination value to “no”.

The method for generating the first guidance information is not limited to the above example. For example, the first guidance information acquisition unit 2003 may generate (or otherwise acquire) the first guidance information using a trained model (also referred to as the guidance action calculation AI) that has been trained for generating the first guidance information.

Here, the guidance action calculation AI may be trained using a known deep learning technique or the like. The guidance action calculation AI outputs the guided destination area and the customer-specific promotion content in response to input of information such as information indicating the status of the customer in the store (check-in notification and position information), the customer information or attribute information, the congestion degree level of each area, and the promotion content. In this case, the first guidance information acquisition unit 2003 inputs information to the guidance action calculation AI, and acquires, as the first guidance information, a guided destination area and customer-specific promotion content.

The first guidance information output by the guidance action calculation AI is preferably information for effectively guiding the customer in the same manner as described above. For example, as a determination criterion for generating information for guiding the customer, the guidance action calculation AI may preferentially select an area having a low congestion degree level among congestion degree levels in the input information. Accordingly, as the guided area in the first guidance information output by the guidance action calculation AI, an area having a low congestion degree level is selected.

For example, as the determination criterion for generating the information for guiding the customer, the guidance action calculation AI may also set a weight of age and gender to be large among the customer information in the input information, and preferentially select an area where merchandise with high sales volumes for the age and the gender of the customer is provided. Accordingly, as the guided area in the first guidance information output by the guidance action calculation AI, an optimum area is selected according to the age and the gender of the customer.

In the above example, the first guidance information acquisition unit 2003 determines the status of the customer in the store, but the disclosure is not limited thereto, and the guidance action calculation AI may determine the status of the customer. In this case, the first guidance information acquisition unit 2003 includes information (various notifications and position information) that allows determining the status of the customer in the input information and inputs the input information to the guidance action calculation AI. It is assumed that the guidance action calculation AI determines (or infers) the status of the customer based on the various notifications, the position information, and the like in the input information, and to output the guided destination area and the customer-specific promotion content based on the status of the customer and other information in the input information. Accordingly, the guided destination area can be changed according to the status of the customer in the store.

The customer-specific promotion content may include, for example, a discount coupon applicable to various merchandise. A budget amount of the discount coupon may be stored in the guidance action calculation AI, and the budget amount of the discount coupon in the customer-specific promotion content output by the guidance action calculation AI may be determined according to the congestion degree level, the customer information, and the like input to the guidance action calculation AI.

The second guidance information acquisition unit 2004 is an example of a third acquisition unit. The second guidance information acquisition unit 2004 generates a prompt (query text) for the sentence generation LLM 226 based on the first guidance information acquired by the first guidance information acquisition unit 2003.

Here, the prompt includes at least the contents of the first guidance information. The prompt also includes an instruction text (query text) for instructing a response format and other details of the second guidance information to be generated. For example, it is preferable that the prompt includes specific instruction content such as “output including a reason for proposing the guided area to the customer” or “output including a reason for proposing the customer-specific promotion content to the customer”. The query text may also be selected from among a plurality of preset templates based on the customer information, the attribute information, the congestion degree level, the customer-specific promotion, or the like.

The second guidance information acquisition unit 2004 inputs the generated prompt to the sentence generation LLM 226 and acquires the second guidance information as output by the sentence generation LLM 226.

The second guidance information includes a guidance sentence and a promotion sentence output by the sentence generation LLM 226. In this context, the guidance sentence is text guiding the customer to a guided area. The promotion sentence is text generated based on the customer-specific promotion content for a purpose of sales promotion or advertising.

When the second guidance information is acquired from the sentence generation LLM 226, the second guidance information acquisition unit 2004 transmits the acquired second guidance information to the mobile terminal 10 in cooperation with the communication processing unit 2001. Here, a transmission destination of the second guidance information is the mobile terminal 10 of the customer (customer ID) related to derivation of the second guidance information.

The storage control unit 2005 performs data management for various types of information stored in the memory unit 204. For example, the storage control unit 2005 controls processing of storing the various types of information in the memory unit 204.

Upon receiving the position information for the customer from the mobile terminal 10, the storage control unit 2005 stores the position information in the customer record DB 227 as the in-store position information. For example, upon receiving the check-in notification from the mobile terminal 10, the storage control unit 2005 stores the position information in the customer record DB 227 in association with the customer ID specified by the notification. Upon receiving the position information from the mobile terminal 10 at timing other than the above-described timing, the storage control unit 2005 stores the position information in the customer record DB 227 in association with the customer ID received together with the position information. When the customer ID of the customer is not registered in the customer master 223, the storage control unit 2005 stores the attribute information extracted from the face image or the like of the customer in the customer ID field. The storage control unit 2005 stores the position information acquired together with the attribute information in the customer record DB 227 in association with the attribute information.

Here, the customer record information stored in the customer record DB 227 by the storage control unit 2005 is information that associates a guidance content provided to the customer with an action of the customer in the store. Therefore, the customer record DB 227 can be used for analysis or the like regarding whether the guidance content provided to the customer contributes to the action of the customer.

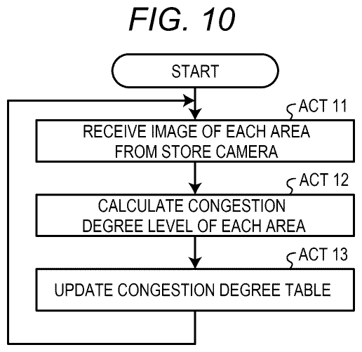

Next, a flow of processing performed by the store server 20 will be described with reference to FIG. 10. FIG. 10 is a flowchart showing an example of congestion degree calculation processing performed by the store server 20 according to the embodiment.

First, the communication processing unit 2001 of the store server 20 receives the area image of each area from the store camera 30 provided in each area in the store (ACT 11). Next, the congestion degree calculation unit 2002 of the store server 20 calculates, using a known image recognition technique or the like, the congestion degree level of each area based on the area image of each area received in ACT 11 (ACT 12).

The congestion degree calculation unit 2002 of the store server 20 updates the congestion degree table 224 based on the congestion degree level of each area calculated in ACT 12 (ACT 13).

The congestion degree calculation unit 2002 repeatedly performs the congestion degree calculation processing at a short time interval such as one minute intervals. Accordingly, the congestion degree calculation unit 2002 can acquire the congestion situation in the store in real time or near real time.

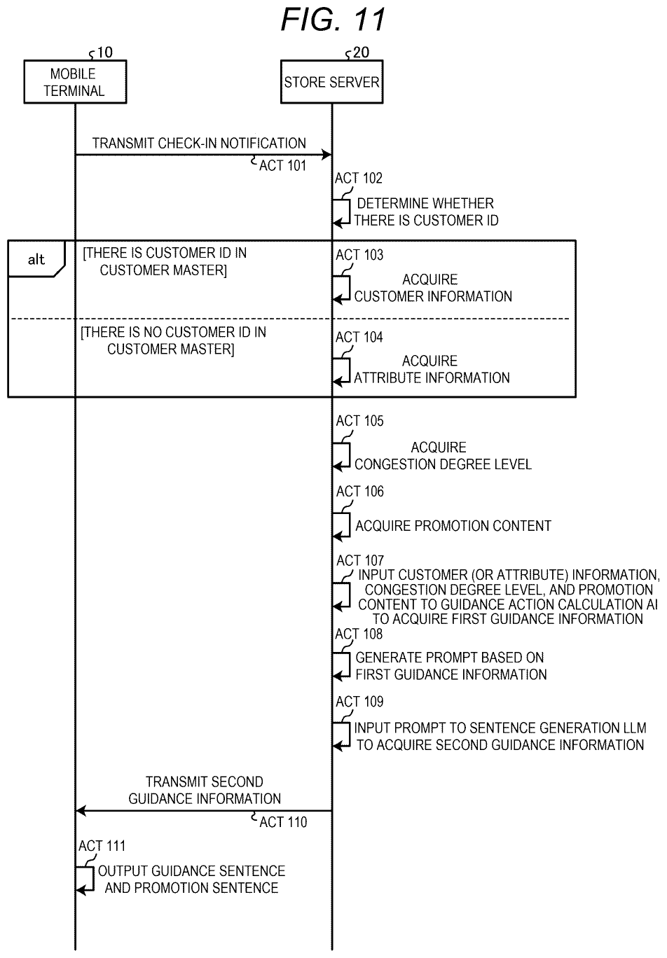

Next, a flow of control processing of the mobile terminal 10 and the store server 20 executed when the customer arrives at the store will be described with reference to FIG. 11. FIG. 11 is a sequence diagram showing an example of the control processing performed by the mobile terminal 10 and the store server 20 according to the embodiment. The sequence diagram shown in FIG. 11 shows a processing example in a case where the customer is guided according to the congestion degree of each area in the store when the customer arrives at the store. In this processing, a case where the first guidance information is generated using the guidance action calculation AI will be described.

First, upon receiving the check-in confirmation instruction from the operation unit 107, the communication processing unit 1001 of the mobile terminal 10 transmits, to the store server 20, the check-in notification including the customer ID, the customer image captured by the imaging unit 108, and the position information acquired by the positioning unit 109 (ACT 101).

When the store server 20 receives the check-in notification from the mobile terminal 10, the first guidance information acquisition unit 2003 refers to the customer master 223 to determine whether there is a corresponding customer ID (ACT 102).

When there is the corresponding customer ID in the customer master 223 (ACT 102; Yes), the first guidance information acquisition unit 2003 acquires, from the customer master 223, the customer information corresponding to the customer ID contained in the check-in notification (ACT 103), and proceeds to ACT 105. When there is no corresponding customer ID in the customer master 223 (ACT 102; No), the first guidance information acquisition unit 2003 acquires the attribute information based on the customer image in the check-in notification (ACT 104).

Subsequently, the first guidance information acquisition unit 2003 refers to the congestion degree table 224 to acquire the congestion degree level of each area (ACT 105). Next, the first guidance information acquisition unit 2003 refers to the promotion DB 225 and acquires the promotion content corresponding to the promotion ID whose promotion flag is ON (ACT 106).

Then, the first guidance information acquisition unit 2003 inputs, to the guidance action calculation AI, the input information including the customer information acquired from the customer master 223 or the attribute information acquired from the customer image, the congestion degree level of each area acquired from the congestion degree table 224, and the promotion content acquired from the promotion DB 225. Then, the first guidance information including the guided area and the customer-specific promotion content output by the guidance action calculation AI is acquired (ACT 107).

The input information received by the guidance action calculation AI may include the position information indicating the status of the customer (a status of starting shopping) in the store. In this case, the guidance action calculation AI outputs an area corresponding to the status of the customer in the store as the guided area. For example, in this processing, the guidance action calculation AI outputs an area other than the checkout area as the guided area.

Subsequently, the second guidance information acquisition unit 2004 of the store server 20 generates the prompt based on the first guidance information acquired in ACT 107 (ACT 108). Next, the second guidance information acquisition unit 2004 inputs the prompt generated in ACT 108 to the sentence generation LLM 226 and thus acquires the second guidance information including the guidance sentence and the promotion sentence as output by the sentence generation LLM 226 (ACT 109).

Subsequently, the communication processing unit 2001 transmits the second guidance information to the mobile terminal 10 (ACT 110).

In the mobile terminal 10, when the second guidance information is received from the store server 20, the display control unit 1002 displays, on the display unit 106, the guidance sentence and the promotion sentence provided in the second guidance information (ACT 111).

By the above-described processing, the store server 20 determines the guided destination area for the customer based on the status of the customer and the congestion degree of each area in the store when the customer arrives at the store. Then, the guidance sentence for guiding the customer to the guided destination area is provided to the customer. Therefore, the store server 20 can guide the customer according to the congestion situation in the store.

After the above-described processing, the store server 20 executes the processing of ACT 105 to ACT 109 based on the position information, the customer ID (or the attribute information), and the like transmitted from the mobile terminal 10, thereby providing the customer with a guidance sentence for guiding to the guided destination according to the status of the customer in the store. Accordingly, the store server 20 can guide the customer to an area that avoids congestion during use of the store. Therefore, the store server 20 can improve convenience for the customer at the store.

As described above, the store server 20 (an example of an information processing apparatus) according to the embodiment acquires the congestion degree of each area in the store. The status information indicating the status of the customer is also acquired. In addition, based on the congestion degree of each area and the status information for the customer, the guided destination area that is the guided destination for the customer is determined. In addition, the prompt including the guided destination area is input to the sentence generation LLM 226, and the second guidance information including the guidance sentence for guiding the customer to the guided destination area generated by the sentence generation LLM 226 is acquired. Then, the acquired second guidance information is transmitted to the mobile terminal 10.

Accordingly, the store server 20 can obtain the guidance sentence indicating the area to which the customer is to be guided according to the congestion degree of the area in the store and the status of the customer in the store. Therefore, the store server 20 can guide the customer according to the congestion degree of each area in the store.

The above-described embodiment can be appropriately modified and implemented by changing a part of the configurations or functions of each of the above-described apparatuses. Hereinafter, several modifications will be described as additional embodiments. In the following, differences from the already described embodiment will be mainly described, the same reference symbols will be used for the same components or aspects as already described, and detailed description thereof may be omitted from subsequent discussion. In addition, modifications described below may be individually implemented or may be implemented in combination with each other as appropriate.

### Modification 1

In the an embodiment, the registration of the merchandise being purchased by the customer is performed by the checkout apparatus 40, but the disclosure is not limited thereto, and the customer may register the merchandise using the mobile terminal 10.

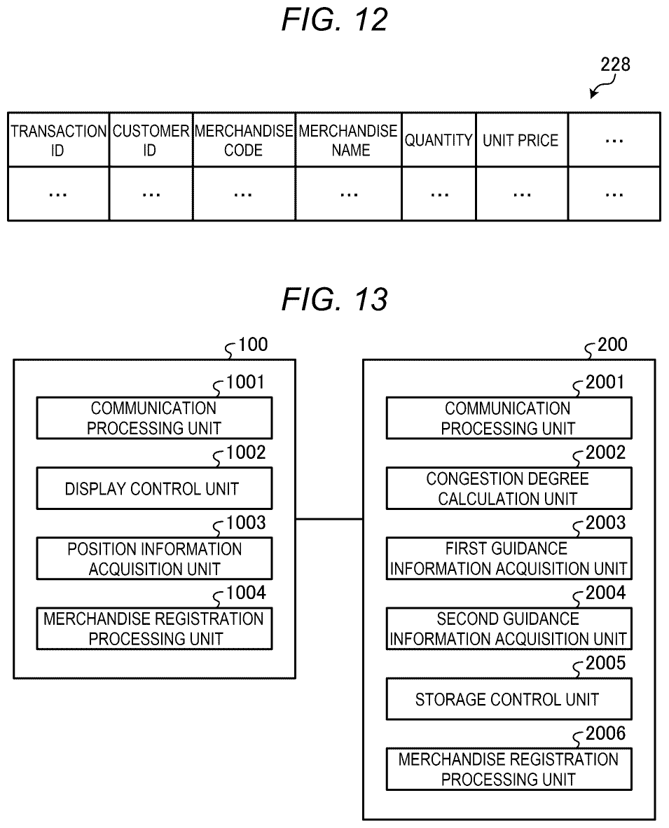

First, in addition to the configuration described in FIG. 3, the store server 20 according to this modification stores, in the memory unit 204, a merchandise registration file 228 (see FIG. 12) for tracking the merchandise registered by the customer using the mobile terminal 10.

FIG. 12 shows an example of a data configuration of the merchandise registration file 228. As shown in FIG. 12, the merchandise registration file 228 stores the customer ID, the merchandise code, and the merchandise information (for example, a merchandise name, quantity, and a unit price) in association with a transaction ID for specifying a transaction.

The transaction ID can be numerical information or the like issued in ascending order. The transaction ID may be issued at the time of check-in, for example. In the customer ID field, the customer ID transmitted from the mobile terminal 10 at check-in is registered. When the customer ID is not registered in the customer master 223, the customer ID field may be empty. In the customer ID field, the attribute information extracted from the face image of the customer or the like may be stored instead of the customer ID.

The merchandise code of a registered merchandise item is registered in a merchandise code field. In the merchandise information field, the merchandise name, the quantity, the unit price, and the like of the merchandise corresponding to the merchandise code are registered. Here, the merchandise name and the unit price correspond to the merchandise information registered in the merchandise master 222.

Next, a functional configuration of the mobile terminal 10 and the store server 20 according to this modification will be described with reference to FIG. 13. FIG. 13 is a block diagram depicting aspects of the functional configuration of the mobile terminal 10 and the store server 20 according to a first modification.

As shown in FIG. 13, the control unit 100 of the mobile terminal 10 includes a merchandise registration processing unit 1004 in addition to the communication processing unit 1001, the display control unit 1002, and the position information acquisition unit 1003 already described above.

The merchandise registration processing unit 1004 performs processing related to the registration of the merchandise being purchased by the customer. Specifically, along with the check-in to the store, the transaction ID provided from the store server 20 is acquired and retained in the RAM or the like.

When an image of the code symbol on the merchandise is captured via the imaging unit 108 after the check-in to the store, the merchandise registration processing unit 1004 extracts or decodes the merchandise code from the code symbol. Next, the merchandise registration processing unit 1004 transmits a merchandise registration notification including the acquired merchandise code and the transaction ID to the store server 20. The merchandise registration processing unit 1004 may also include, in the merchandise registration notification, the customer ID of the customer. The merchandise registration processing unit 1004 may also include, in the merchandise registration notification, position information acquired by the positioning unit 109.

Here, the merchandise registration notification is information for instructing storage (registration) of the merchandise information corresponding to the merchandise code in the merchandise registration file 228 of the store server 20 in association with the transaction ID assigned to the apparatus.

The control unit 200 of the store server 20 includes a merchandise registration processing unit 2006 in addition to the communication processing unit 2001, the congestion degree calculation unit 2002, the first guidance information acquisition unit 2003, the second guidance information acquisition unit 2004, and the storage control unit 2005 described above.

The merchandise registration processing unit 2006 performs processing related to the registration of the merchandise being purchased by the customer. Specifically, the merchandise registration processing unit 2006 issues (and generates) the transaction ID in response to the check-in of the customer, and stores the issued transaction ID in the merchandise registration file 228 in association with the customer ID or the attribute information from the check-in notification.

Upon receiving the merchandise registration notification from the mobile terminal 10, the merchandise registration processing unit 2006 acquires, from the merchandise master 222, the merchandise information corresponding to the merchandise code contained in the merchandise registration notification. The merchandise registration processing unit 2006 registers the merchandise being purchased by the customer by storing the acquired merchandise information in the merchandise registration file 228 in association with a transaction ID or the like. The merchandise registration processing unit 2006 notifies the mobile terminal 10 of registration completion by transmitting the acquired merchandise information to the mobile terminal 10 that sent the merchandise registration notification.

The merchandise registration processing unit 1004 of the mobile terminal 10 cooperates with the display control unit 1002 to display the merchandise information transmitted from the mobile terminal 10. Accordingly, the customer who operates the mobile terminal 10 can check the registered merchandise. The customer who operates the mobile terminal 10 repeatedly executes the merchandise registration operation to register the merchandise the customer wishes to purchase.

When a checkout execution instruction is received from the operation unit 107, the merchandise registration processing unit 1004 of the mobile terminal 10 displays, on the display unit 106, a screen where the transaction ID is converted into a code symbol. The merchandise registration processing unit 1004 may transmit a checkout instruction notification including the transaction ID to the store server 20 in response to the checkout execution instruction. The merchandise registration processing unit 1004 may include, in the checkout instruction notification, the customer ID of the customer who operates the apparatus and the position information acquired by the positioning unit 109.

When the code symbol obtained by encoding the transaction ID is displayed on the display unit 106, the operator of the mobile terminal 10 causes the checkout apparatus 40 to read the code symbol (transaction ID) via a code reading unit or the like at the checkout apparatus 40 to be used for checkout.

When the transaction ID is read, the checkout apparatus 40 in this modification queries the store server 20 with the transaction ID to acquire the merchandise information associated with the transaction ID from the store server 20. The checkout apparatus 40 performs checkout processing based on the acquired merchandise information. Specifically, the checkout apparatus 40 calculates a total amount based on the merchandise information and executes checkout processing for settling the total amount with the amount to be paid by the customer. When the checkout processing is completed, the checkout apparatus 40 transmits a checkout completion notification including the transaction ID to the store server 20.

Upon receiving a first checkout completion notification, the merchandise registration processing unit 2006 of the store server 20 cooperates with the storage control unit 2005 to store the merchandise information associated with the transaction ID in the customer master 223 as a purchase history for the customer ID associated with the transaction ID.

Upon receiving the first checkout completion notification, the merchandise registration processing unit 2006 of the store server 20 transmits a second checkout completion notification indicating that the checkout has been completed to the mobile terminal 10 corresponding to the transaction ID included in the first checkout completion notification. Upon receiving the second checkout completion notification from the store server 20, the mobile terminal 10 ends processing related to purchase support and action support in the store such as position information acquisition.

In a modification, the customer can register merchandise for purchase using the mobile terminal 10. Accordingly, the customer who operates the mobile terminal 10 can perform the merchandise registration and provide the checkout instruction using the mobile terminal 10 while receiving guidance regarding a guided (suggested) destination.

In this modification, the first guidance information acquisition unit 2003 may determine the status of the customer in the store and generate (or otherwise acquire) the first guidance information based on the merchandise registration notification or the checkout instruction notification transmitted from the mobile terminal 10. For example, when the merchandise registration notification is received from the mobile terminal 10, the first guidance information acquisition unit 2003 identifies that the customer is shopping in the store or moving around in the store. When the checkout instruction notification is received from the mobile terminal 10, the first guidance information acquisition unit 2003 determines that the customer is now performing checkout.

Accordingly, the store server 20 can provide the mobile terminal 10 with the second guidance information indicating the guided (suggested) destination for the customer upon receiving the merchandise registration notification or the checkout instruction notification from the mobile terminal 10. Therefore, the store server 20 can provide the customer with a guided destination suitable for the current status of the customer.

When the registered merchandise information is stored in the merchandise registration file 228 in association with a transaction ID (or a customer ID) contained in the merchandise registration notification when the merchandise registration notification is received, the first guidance information acquisition unit 2003 may determine the guided destination area based on the registered merchandise information. For example, the first guidance information acquisition unit 2003 may determine, as the guided destination, an area for selling merchandise related to the already registered merchandise (merchandise information) based on a combination of merchandise (items) that tend to be purchased together.

Accordingly, the store server 20 can select the guided destination in consideration of the already registered merchandise, and it is possible to attract the customer to the guided destination area.

### Second Modification

In an embodiment, the position of the customer in the store is acquired from the mobile terminal 10, but the disclosure is not limited thereto. For example, the store server 20 may acquire the position of the customer from the area image captured by the store camera 30.

In this case, the control unit 200 (for example, the congestion degree calculation unit 2002) of the store server 20 acquires, from the area image, the face feature, the attribute information, the position information, and the like of the customer depicted in the area image. Here, the position information may indicate an area corresponding to the area image. For example, the control unit 200 of the store server 20 may track a movement path of the customer by sequentially tracing areas where a customer having the same (or similar) face feature or attribute information appears in images captured by the store cameras 30 in different areas, and store the movement path in the customer record DB 227. For example, when a store camera 30 is provided at the signage terminal 50, the control unit 200 acquires the face feature and the attribute information of the customer facing the signage terminal 50, and the position information indicating the area where the signage terminal 50 is provided.

The first guidance information acquisition unit 2003 of the store server 20 may generate the first guidance information by performing the same processing as in an above-described embodiment, based on the attribute information, the position information, and the like of the customer acquired from the image captured by the signage terminal 50. In this case, the transmission destination of the second guidance information may be a signage terminal 50. Specifically, the store server 20 causes the signage terminal 50 to display a screen based on the second guidance information by transmitting the second guidance information to the signage terminal 50.

Accordingly, the store server 20 can present a guided destination suitable for the customer presently facing the signage terminal 50 via a display of such information on the signage terminal 50. Therefore, substantially similar effects as those in an above-described embodiment can be obtained.

In an embodiment, the check-in (check-in notification) is performed using the mobile terminal 10, but the disclosure is not limited thereto, and the check-in may be performed using an apparatus other than the mobile terminal 10.

For example, a dedicated check-in terminal may be provided at the entrance of the store, and the customer may perform a check-in using the check-in terminal. In this case, the check-in terminal reads a member ID from a member card, a user terminal, or the like provided by the customer, and performs the processing related to check-in in a manner similar to that already described above. In some examples, the check-in terminal may capture the face image of the customer and transmit the face image to the store server 20 to perform check-in for the customer.

When the check-in is performed using a check-in terminal, it is possible to obtain substantially the same effects as those in the above-described embodiment without using a mobile terminal 10 by presenting the second guidance information via the signage terminal(s) 50.

### Third Modification

In an embodiment, the congestion degree is calculated based on an area image of each area captured by a store camera 30, but the disclosure is not limited thereto, and the congestion degree may be calculated according to entrance or exit gate information provided by an entrance or exit gate for areas instead.

In this case, the store server 20 counts the number of people present in an area based on the number of people passing through the entrance or exit gate for the area. Then, the store server 20 may calculate the congestion degree based on the number of people in each area.

### Fourth Modification

In an embodiment, the first guidance information acquisition unit 2003 inputs the customer information or the attribute information, the congestion degree level of each area, and the promotion content to the guidance action calculation AI, but the input information is not limited thereto. For example, the input information may include the position information for the customer, information about a location of merchandise in each area from the store server 20, in other words, information corresponding to an in-store map, and a past congestion degree level that can be acquired by the congestion degree calculation unit 2002 from the congestion degree table 224.

Accordingly, the guidance action calculation AI can be expected to output the first guidance information with high accuracy.

### Fifth Modification

In an embodiment, the first guidance information acquisition unit 2003 generates the first guidance information including the area that is the guided (suggested) destination along with the promotion content as selected based on the customer information (acquired from the customer master 223) or the customer attribute information (acquired from the customer image), the congestion degree levels acquired from the congestion degree table 224, and the various promotion content acquired from the promotion DB 225.

However, the disclosure is not limited thereto, and the first guidance information acquisition unit 2003 may select the area that is to be the guided destination based only on the customer information or customer attribute information and the congestion degree levels acquired from the congestion degree table 224.

### Sixth Modification

The calculation of the congestion degree level by the congestion degree calculation unit 2002 may be executed on a cloud server or the like instead of being executed by the store server 20. In this case, the congestion degree level calculated via the cloud server is transmitted to the store server 20, and the store server 20 updates the congestion degree table 224 upon receiving the congestion degree level.

Programs executed by the guidance promotion system 1 according to an embodiment and modifications thereof may be stored on a computer connected to a network such as the Internet and provided by being downloaded via the network. In addition, the programs executed by the guidance promotion system 1 may be provided or distributed via a network such as the Internet.

The programs executed by the apparatuses of the above-described embodiment can be incorporated in advance in a ROM, a storage unit, or the like. The programs may be provided by being recorded in a non-transitory, computer-readable recording medium such as a CD-ROM, a flexible disk (FD), a CD-R, or a digital versatile disk (DVD) as a file in an installable or executable format.

While certain embodiments have been described, these embodiments have been presented by way of example only and are not intended to limit the scope of the present disclosure. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the present disclosure.

What is claimed is:

1. An in-store customer guidance system, comprising:
a camera;
a checkout apparatus in a first region of a store; and
a store server including:
a storage unit,
a communication unit, and
a control unit configured to:
identify a degree of congestion for each of a plurality regions of the store including the first region,
store the identified degree of congestion for each of the plurality of regions in the storage unit,
determine a current status of a customer in the store,
select a region of the store in the plurality of regions as a suggested destination based on the stored degree of congestion for each of the plurality of regions and the determined current status of the customer,
generate a prompt including the suggested destination,
input the prompt to a generative AI trained to generate a customer guidance response for guiding the customer to the suggested destination, and
output the customer guidance response to the customer.

2. The in-store customer guidance system according to claim 1, wherein the current status of the customer is provided based on a detected location of the customer in the store.

3. The in-store customer guidance system according to claim 1, wherein the customer guidance response is output to a mobile terminal of the customer via the communication unit.

4. The in-store customer guidance system according to claim 1, further comprising:
a signage terminal in the store, wherein
the customer guidance response is output to the signage terminal via the communication unit.

5. The in-store customer guidance system according to claim 1, wherein
the storage unit stores promotional content, and
the control unit is further configured to:
select promotional content from the storage unit based on the degree of congestion for each of the plurality of regions and the current status of the customer, and
present the promotional content to the customer.

6. The in-store customer guidance system according to claim 5, wherein the selected promotional content is included in the prompt.

7. The in-store customer guidance system according to claim 5, wherein
the control unit is further configured to:
receive a customer check-in operation, and
identify a customer attribute based on the customer check-in operation, and
the promotional content is additionally selected based on the customer attribute.

8. The in-store customer guidance system according to claim 5, wherein
the control unit is further configured to:
receive an image of the customer from the camera via the communication unit, and
identify a customer attribute based on the image of the customer, and
the promotional content is additionally selected based on the customer attribute.

9. The in-store customer guidance system according to claim 1, wherein the current status of the customer is determined based on a usage of a mobile terminal in the store.

10. The in-store customer guidance system according to claim 1, wherein the degree of congestion for each of the plurality of regions is identified based on analysis of camera images of each of the plurality of regions.

11. The in-store customer guidance system according to claim 1, wherein the suggested destination is a region in the plurality of regions other than the first region when the identified degree of congestion in the first region is above a threshold level and the current status of the customer is ready for checkout.

12. A store server for providing an in-store customer guidance system, the store server comprising:
a storage unit;
a communication unit; and
a control unit configured to:
identify a degree of congestion for each of a plurality regions of a store including a first region with a checkout apparatus therein,
store the identified degree of congestion for each of the plurality of regions in the storage unit,
determine a current status of a customer in the store,
select a region of the store in the plurality of regions as a suggested destination based on the stored degree of congestion for each of the plurality of regions and the determined current status of the customer,
generate a prompt including the suggested destination;
input the prompt to a generative AI trained to generate a customer guidance response for guiding the customer to the suggested destination, and
output the customer guidance response to the customer.

13. The store server according to claim 12, wherein the current status of the customer is provided based on a detected location of the customer in the store.

14. The store server according to claim 12, wherein the customer guidance response is output to a mobile terminal of the customer or a signage terminal via the communication unit.

15. The store server according to claim 12, wherein
the storage unit stores promotional content, and
the control unit is further configured to:
select promotional content from the storage unit based on the degree of congestion for each of the plurality of regions and the current status of the customer, and
present the promotional content to the customer.

16. The store server according to claim 15, wherein
the control unit is further configured to:
receive a customer check-in operation, and
identify a customer attribute based on the customer check-in operation, and
the promotional content is additionally selected based on the customer attribute.

17. The store server according to claim 15, wherein
the control unit is further configured to:
receive an image of the customer from the camera via the communication unit, and
identify a customer attribute based on the image of the customer, and
the promotional content is additionally selected based on the customer attribute.

18. The store server according to claim 12, wherein the current status of the customer is determined based on a usage of a mobile terminal in the store.

19. The store server according to claim 12, wherein the degree of congestion for each of the plurality of regions is identified based on analysis of camera images of each of the plurality of regions.

20. The store server according to claim 12, wherein the suggested destination is a region in the plurality of regions other than the first region when the identified degree of congestion in the first region is above a threshold level and the current status of the customer is ready for checkout.
